(19) United States
(12) Patent Application Publication
(10) Pub. No.: US 2021/0107219 A1
(43) Pub. Date: Apr. 15, 2021

(54) PRINTING SYSTEMS WITH MOVABLE DATA CONNECTORS

(71) Applicant: HEWLETT-PACKARD DEVELOPMENT COMPANY, L.P., Spring, TX (US)

(72) Inventor: Kevin E Swier, Corvallis, OR (US)

(21) Appl. No.: 16/499,303

(22) PCT Filed: Oct. 5, 2017
(86) PCT No.: PCT/US2017/055251

§ 371 Date: Sep. 29, 2019

(51) Int. Cl. B29C 64/241; B29C 64/245; B33Y 50/02

(52) U.S. Cl. CPC B29C 64/241; B29C 64/209; B33Y 50/02; B29C 64/245

(57) ABSTRACT

A printing system includes a rail and an electrical connector coupled to the rail. The rail is moveable between a first position where the electrical connector is disengaged from contacts of a supply container chip and a second position where the electrical connector is engaged with the contacts of a supply container chip.

### BACKGROUND

Printing technologies may be used to create three-dimensional (3D) objects, for example, from data output from a computerized modeling source. For example, a 3D object may be designed using a computer program (e.g., a computer aided design (CAD) application) to generate a 3D model of the object, and the computer may output the data of the 3D model to a printing system capable of forming the solid 3D object. Solid free-form fabrication (or layer manufacturing) may be defined generally as a fabrication technology used to build a 3D object using layer by layer or point-by-point fabrication. With this fabrication process, complex shapes may be formed without the use of a pre-shaped die or mold.

### BRIEF DESCRIPTION OF THE DRAWINGS

FIGS. 1A-1B are block diagrams illustrating one example of a chip access device of a printing system.

FIG. 2 is a block diagram illustrating one example of a three-dimensional (3D) printing system.

FIGS. 3A-3C illustrate another example of a chip access device of a printing system.

FIG. 4 illustrates one example of a supply container.

FIG. 5A-5B illustrate one example of the operation of the chip access device of FIGS. 3A-3C.

FIG. 6 is a flow diagram illustrating one example of a method for operating a printing system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Three-dimensional (3D) printing systems use build material to create 3D objects. Two-dimensional (2D) printing systems and other types of systems may also use print material for forming text and/or images. The build material and/or other print material supplies should be compatible with the printing systems in which they are used to ensure proper and safe operation of the printing systems.

Accordingly, disclosed herein is a printing system including a data connector. The data connector is moveable between a first position where the data connector is disengaged from an interface of a supply container chip and a second position where the data connector is engaged with the interface of a supply container chip. The supply container chip may store data regarding the type of build material or print material contained within the supply container, the amount of material remaining in the supply container, and/or any other suitable information regarding the supply container and/or the material contained within the supply container. With the data connector engaged with the interface of a supply container chip, the chip may be accessed by the printing system for read and/or write access. With the data connector disengaged from the interface of the supply container chip, the supply container may be removed, replaced, or rotated. In this way, the supply container chip may be used to ensure compatibility of the material contained within the supply container with the printing system, to track the amount of material remaining within the container, and/or to perform and/or track other suitable functions of the printing system.

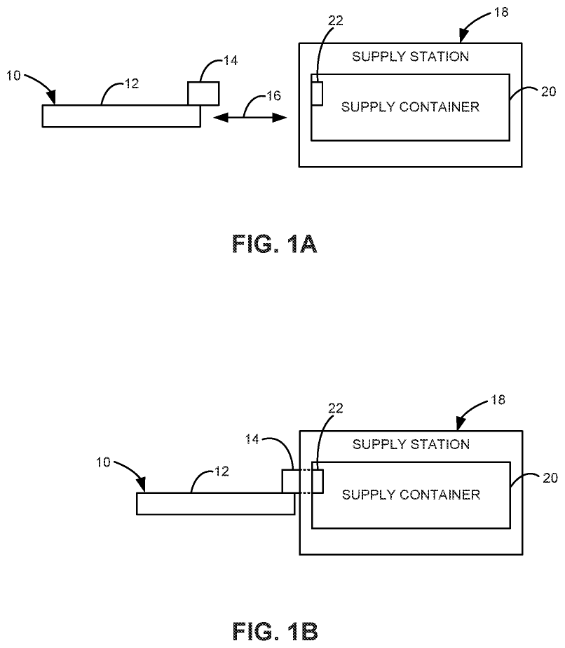

FIGS. 1A-1B are block diagrams illustrating one example of a chip access device 10 of a printing system including a supply station 18. Supply station 18 is to receive a supply container 20. Supply container 20 includes a chip 22 or another electronic device (e.g., processor, etc.). Supply container 20 may be removably installed in supply station 18 such that an empty supply container 20 may be removed from supply station 18 and replaced with a full supply container 20. Chip 22 may include a memory storing information about supply container 20 and the material contained within supply container 20. For example, chip 22 may store a code that identifies the material and the amount of material remaining within supply container 20. Supply station 18 may be a rotatable supply station that may be rotated with a supply container 20 installed within the supply station. In one example, supply station 18 may be rotated in a first direction to remove material from supply container 20 and rotated in a second direction opposite to the first direction to add material to supply container 20.

Chip access device 10 includes a rail 12 and a data connector 14 coupled to the rail 12. The rail 12 and thus the data connector 14 is moveable, as indicated at 16, between a first position as illustrated in FIG. 1A where the data connector 14 is disengaged from an interface of a supply container chip 22 and a second position as illustrated in FIG. 1B where the data connector 14 is engaged with the interface of a supply container chip 22. In one example as illustrated by 16, the rail 12 and thus the data connector 14 is moveable in a direction parallel to a long axis of the supply container 20. In one example, the data connector 14 is moved to the second position as illustrated in FIG. 1B when the supply station 18 is stationary and moved to the first position as illustrated in FIG. 1A prior to the supply station 18 being rotated. With the data connector in the second position as illustrated in FIG. 1B, the chip 22 may be accessed for read or write operations. Data connector 14 and chip 22 may include analog or digital electrical interfaces, optical interfaces, and/or other suitable interfaces for providing a data connection between data connector 14 and chip 22.

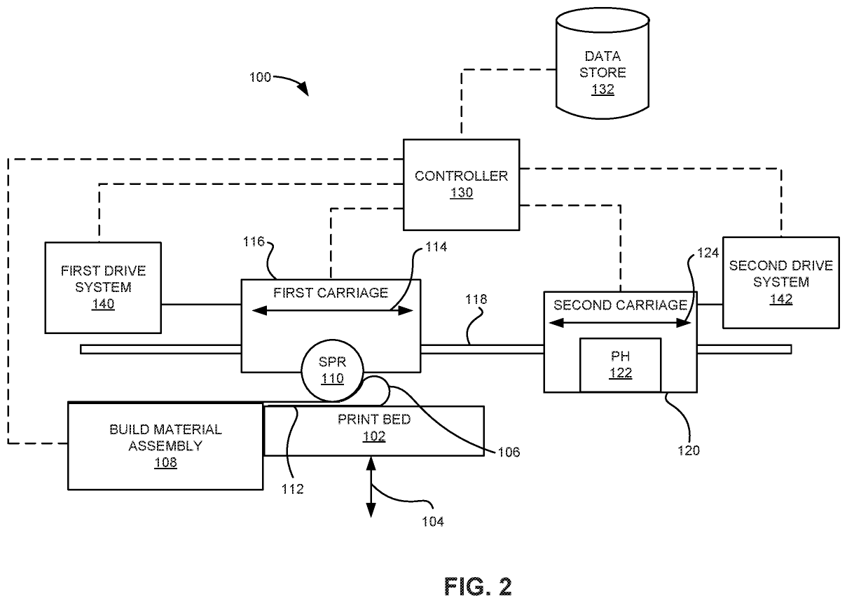

FIG. 2 is a block diagram illustrating one example of a 3D printing system 100. 3D printing system 100 includes a print bed 102, a build material assembly 108, a spreader 110, a first carriage 116, a rail 118, a second carriage 120, a printhead 122, a controller 130, a data store 132, a first drive system 140, and a second drive system 142. In other examples, 3D printing system 100 may include additional components and some of the components described herein may be removed and/or modified.

Print bed 102 may be positioned on a platform (not shown) that moves in a vertical direction to thus cause the print bed 102 to move in a vertical direction as indicated by arrow 104. 3D objects or parts are generated from a build material 106 within a build envelope, which may be defined as the three-dimensional space on the top of print bed 102. Build material 106 is supplied by build material assembly 108. In one example, build material assembly 108 includes chip access device 10 and supply station 18 previously described and illustrated with reference to FIGS. 1A-1B.

Build material 106 may be applied or spread as desired onto print bed 102 by spreader 110 to form a build material layer 112. For example, build material 106 may be provided at build material assembly 108 at a slightly higher elevation as compared to the height of the surface of print bed 102 and spreader 110 may move in a horizontal direction from a location above build material assembly 108 to a location across print bed 102 from build material assembly 108, as indicated by the arrow 114. Build material assembly 108 may include a rotatable supply station 18 (FIGS. 1A-1B) to provide the build material layer 112 from a supply container 20 to a position to be spread onto print bed 102 or a previously formed build material layer.

In one example, build material 106 is a powder-based build material. As used herein, the term powder-based build material is intended to encompass dry powder-based materials, wet powder-based materials, particulate materials, granular materials, etc. Build material 106 may be formed from, or may include, short fibers that may, for example, have been cut into short lengths from long strands or threads of material. Build material 106 may include plastics, ceramics, and/or metals. In other examples, build material 106 may be used with other suitable build materials, with suitable modification if appropriate. In still other examples, the build material 106 may be any other suitable form of build material.

Spreader (SPR) 110 may be positioned above print bed 102 such that a relatively small gap exists between spreader 110 and print bed 102. As such, as spreader 110 pushes build material 106 across the surface of print bed 102, a layer of build material 112 may be formed on print bed 102. A similar operation may be performed to form additional build material layers above print bed 102. Spreader 110 may be mounted on first carriage 116, which is movable across print bed 102. First carriage 116 may be movably supported on rail 118 and may be moved along rail 118 such that spreader 110 may be moved from a location above the build material assembly 108 to an opposite end of print bed 102.

Printhead (PH) 122 is mounted to second carriage 120. Although second carriage 120 illustrated in FIG. 2 includes a single printhead 122, in other examples second carriage 120 may support any suitable number of printheads. Second carriage 120 may be movably supported on rail 118 and may be moved along rail 118. Printhead 122 may include a plurality of nozzles (not shown) through which a printing liquid, such as a fusing agent, a chemical binder, an ink, a detailing agent, a cooling agent, or the like, is ejected. Printhead 122 may be, for instance, a thermal inkjet printhead, a piezoelectric printhead, etc., and may extend a width of the print bed 102. Second carriage 120 may be moved across print bed 102 in the horizontal direction as indicated by the arrow 124 to enable printhead 122 to deposit liquid onto desired locations of build material layer 112 through the nozzles. In one example, printhead 122 may be controlled to deposit the liquid at the locations on build material layer 112 that are to be fused together or otherwise solidified. When an energy absorbing fusing agent is used, 3D printing system 100 may further include an energy source (not shown) to apply energy (e.g., heat) onto build material layer 112 to cause the sections of build material 106 upon which the fusing agent has been deposited to be fused together.

Controller 130 may be a computing device, a semiconductor-based microprocessor, an application specific integrated circuit (ASIC), and/or other hardware device, to control the operation of the components of 3D printing system 100. The communication lines between controller 130 and other components of 3D printing system 100 are depicted as dashed lines. Controller 130 may independently control first drive system 140 and second drive system 142 to independently control the movement and/or the speeds of movement of first carriage 116 and second carriage 120, respectively.

Controller 130 is also in communication with data store 132. Data store 132 may include data pertaining to a 3D part to be printed by 3D printing system 100. For example, the data may include the locations in each build material layer 112 that printhead 122 is to deposit printing agent or liquid to form the 3D part. In one example, controller 130 may use the data to control the locations on each of the build material layers 112 that the printhead 122 deposits liquid. Controller 130 may also control the supply of build material 106 by build material assembly 108, the movement of print bed 102, and the movement of spreader 110. In addition, controller 130 may read and/or write data to and from the chip 22 (FIGS. 1A-1B) of a supply container 20.

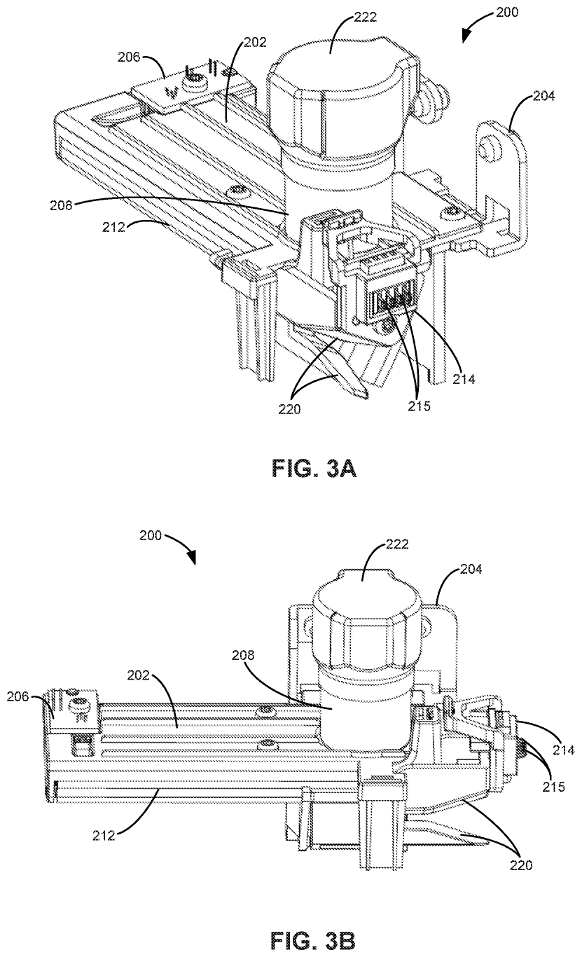

FIG. 3A illustrates a perspective view, FIG. 3B illustrates a side view, and FIG. 3C illustrates an internal view of another example of a chip access device 200 of a printing system. In one example, chip access device 200 provides chip access device 10 of FIGS. 1A and 1B. Chip access device 200 may be part of build material assembly 108 of printing system 100 previously described and illustrated with reference to FIG. 2. In this example, chip access device 200 includes a rail mount 202, a mounting bracket 204, a sensor 206, a motor 208, an encoder 210, a rail 212, a data connector 214, a rack 216 and pinion 218, an alignment component 220, and a dust cover 222. In other examples, chip access device 200 may include additional components and some of the components described herein may be removed and/or modified.

Rail mount 202 is coupled to mounting bracket 204. Mounting bracket 204 may be attached to a fixed portion of build material assembly 108 (FIG. 2). Sensor 206 is coupled to one end of rail mount 202. Sensor 206 may be an optical sensor or another suitable sensor for sensing rail 212. Sensor 206 may be electrically coupled to controller 130 (FIG. 2) to pass sensor data to controller 130.

Motor 208 includes a housing coupled to the mounting bracket 204. Motor 208 may be a direct current (DC) motor (e.g., pulse motor) or another suitable motor. Motor 208 includes a motor shaft 209 (FIG. 3C) orthogonal to rail mount 202 and rail 212. Encoder 210 (FIG. 3C) is attached to motor shaft 209 at the back of motor 208 facing away from rail mount 202 and pinion 218 is attached to motor shaft 209 at the front of motor 208 facing rail mount 202. Dust cover 222 covers encoder 210 and the back of motor 208. Motor 208 and encoder 210 may be electrically coupled to controller 130 (FIG. 2). Controller 130 may receive encoder data from encoder 210 and control the rotation of motor 208. Accordingly, controller 130 may control the position of rail 212 by rotating motor 208 based on feedback from encoder 210.

Rail 212 is movably coupled to rail mount 202. Rack 216 (FIG. 3C) is coupled to rail 212 and engages pinion 218 such that rail 212 moves laterally along rail mount 202 in response to rotation of motor shaft 209 of motor 208. Data connector 214 is coupled to one end of rail 212. In this example, data connector 214 is an electrical connector including spring contacts 215 for contacting contacts of a chip of a supply container. In other examples, data connector 214 may be an optical connector or another suitable connector for interfacing with a chip of a supply container. In this example, data connector 214 includes four spring contacts 215. In other examples, data connector 214 may include any suitable number of contacts. Data connector 214 may be electrically coupled to controller 130 (FIG. 2). Controller 130 may access a chip of a supply container for read and/or write operations through data connector 214.

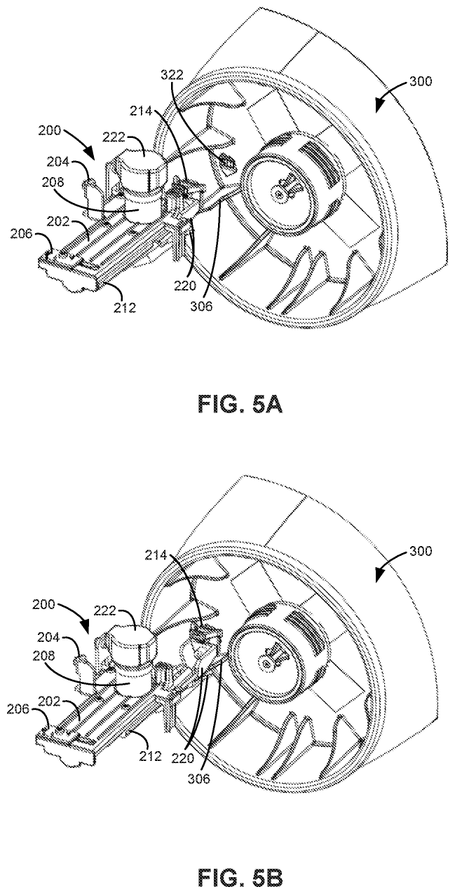

Alignment component 220 is coupled to rail 212 below data connector 214. Alignment component 220 is configured to engage an alignment component of a supply container. In this example, alignment component 220 includes a V-shaped notch. In other examples, alignment component 220 may have another suitable configuration. The operation of chip access device 200 will be described below with reference to FIGS. 5A-5B.

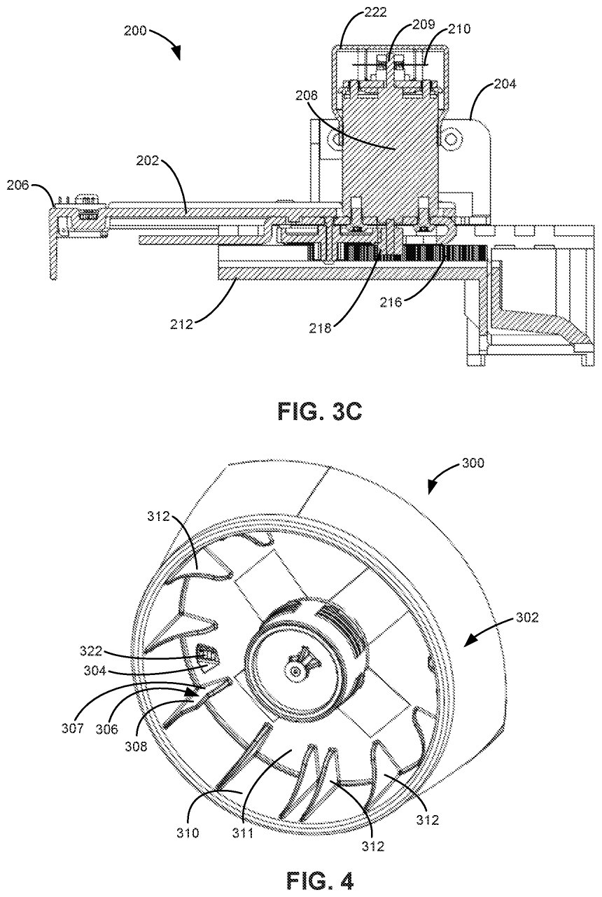

FIG. 4 illustrates one example of a supply container 300. In one example, supply container 300 provides supply container 20 previously described and illustrated with reference to FIGS. 1A-1B. Supply container 300 includes a housing 302, a pocket 304 coupled to housing 302 to receive a chip 322, and an alignment component 306 coupled to housing 302 to align the chip 322 with a chip access device, such as chip access device 200 previously described and illustrated with reference to FIGS. 3A-3C. Alignment component 306 is configured to engage with alignment component 220 of chip access device 200. In this example, alignment component 306 includes a fin. Fin 306 may include a first portion 307 having a first width and a second portion 308 have a second width less than the first width. The second portion 308 of the fin may be rectangular shaped. In other examples, alignment component 306 may have another suitable configuration.

Housing 302 includes a cylindrical sidewall portion 310 and an inner sidewall portion 311 extending between the cylindrical sidewall portion 310. Pocket 304 is coupled to the inner sidewall portion 311. Alignment component 306 is coupled to the cylindrical sidewall portion 310 and the inner sidewall portion 311. Supply container 300 may also include a plurality of fins 312 coupled to the cylindrical sidewall portion 310 and the inner sidewall portion 311. In one example, housing 302, pocket 304, and alignment component 306 are a single integral part (e.g., an injection molded part, a 3D printed part, etc.).

FIGS. 5A-5B illustrate one example of the operation of chip access device 200 previously described and illustrated with reference to FIG. 3A-3C. FIG. 5A illustrates chip access device 200 with rail 212 in a first (i.e., retracted) position where data connector 214 is disengaged from the contacts of chip 322 of supply container 300. FIG. 5B illustrates chip access device 200 with rail 212 in a second (i.e., extended) position where data connector 214 is engaged with the contacts of chip 322 of supply container 300.

As illustrated in FIG. 5A, in the first position rail 212 is fully retracted and sensor 206 indicates that rail 212 is in the first position. In the first position, supply container 300 may be removed or replaced. Also in the first position, supply container 300 may be rotated to remove build material from the supply container or to add build material to the supply container. With supply container 300 in a stationary home position, motor 208 may be operated to move rail 212 to the second position as illustrated in FIG. 5B.

Once rail 212 moves out of the first position, sensor 206 indicates that rail 212 is not in the first position. Encoder 210 indicates the position of rail 212 based on the rotation of motor 208. As rail 212 is moved toward supply container 300, alignment component 220 (e.g., the V-shaped notch) of chip access device 200 engages alignment component 306 (e.g., the fin) of supply container 300 to align data connector 214 with the contacts of chip 322. Once rail 212 is fully extended in the second position, data connector 214 engages the contacts of chip 322. With data connector 214 engaged with the contacts of chip 322, chip 322 may be accessed for read and/or write operations.

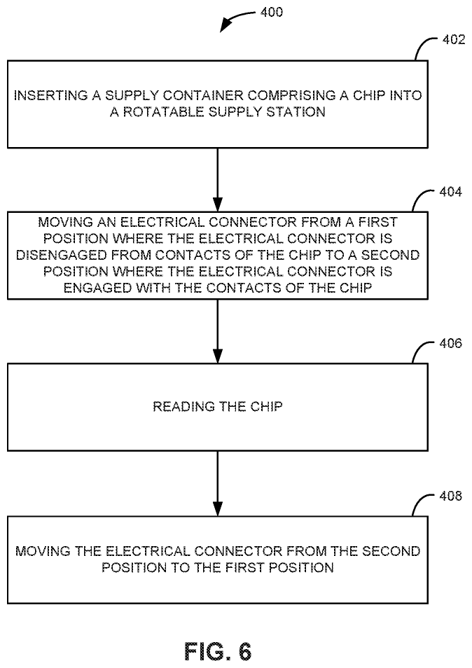

FIG. 6 is a flow diagram illustrating one example of a method 400 for operating a printing system, such as printing system 100 previously described and illustrated with reference to FIG. 2. At 402, method 400 includes inserting a supply container comprising a chip into a rotatable supply station. At 404, method 400 includes moving an electrical connector from a first position where the electrical connector is disengaged from contacts of the chip to a second position where the electrical connector is engaged with the contacts of the chip. At 406, method 400 includes reading the chip. At 408, method 400 includes moving the electrical connector from the second position to the first position.

In one example, method 400 further includes rotating the supply station with the electrical connector in the first position to remove build material from the supply container. In this example, method 400 may also include moving the electrical connector from the first position to the second position, writing the chip to indicate the amount of build material in the supply container, and moving the electrical connector from the second position to the first position. In another example, method 400 further includes rotating the supply station with the electrical connector in the first position to add build material to the supply container. In this example, method 400 may also include moving the electrical connector from the first position to the second position, writing the chip to indicate the amount of build material in the supply container, and moving the electrical connector from the second position to the first position.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A printing system comprising:
a rail; and
an data connector coupled to the rail,
wherein the rail is moveable between a first position where the data connector is disengaged from an interface of a supply container chip and a second position where the data connector is engaged with the interface of a supply container chip.

2. The printing system of claim 1, further comprising:
a motor to move the rail between the first position and the second position.

3. The printing system of claim 1, wherein the data connector is an electrical connector.

4. The printing system of claim 1, wherein the data connector is an optical connector.

5. The printing system of claim 1, further comprising:
a sensor to indicate when the rail is in the first position.

6. The printing system of claim 1, wherein the data connector comprises spring contacts.

7. The printing system of claim 1, further comprising:
an alignment component coupled to the rail, the alignment component to engage with the supply container to align the data connector with the supply container chip when the rail moves to the second position.

8. The printing system of claim 7, wherein the alignment component comprise a V-shaped notch to engage a fin of the supply container when the rail moves to the second position.

9. The printing system of claim 1, wherein the rail is movable in a direction parallel to a long axis of the supply container.

10. A printing system comprising:
an electrical connector; and
a rotatable supply station to receive a supply container, the supply container comprising a chip,
wherein the electrical connector is moveable between a first position where the electrical connector is disengaged from contacts of the chip and a second position where the electrical connector is engaged with the contacts of the chip.

11. The printing system of claim 10, wherein the rotatable supply station is rotated to add or remove build material from the supply container, and
wherein the electrical connector is moved to the second position when the supply station is stationary and moved to the first position prior to the supply station being rotated.

12. The printing system of claim 10, wherein with the electrical connector in the second position, the chip is accessed for read or write operations.

13. A method for operating a printing system, the method comprising:
inserting a supply container comprising a chip into a rotatable supply station;
moving an electrical connector from a first position where the electrical connector is disengaged from contacts of the chip to a second position where the electrical connector is engaged with the contacts of the chip;
reading the chip; and
moving the electrical connector from the second position to the first position.

14. The method of claim 13, further comprising:
rotating the supply station with the electrical connector in the first position to remove build material from the supply container;
moving the electrical connector from the first position to the second position;
writing the chip to indicate the amount of build material in the supply container; and
moving the electrical connector from the second position to the first position.

15. The method of claim 13, further comprising:
rotating the supply station with the electrical connector in the first position to add build material to the supply container;
moving the electrical connector from the first position to the second position;
writing the chip to indicate the amount of build material in the supply container; and
moving the electrical connector from the second position to the first position.
